(19) United States
(12) Patent Application Publication
(10) Pub. No.: US 2020/0053983 A1
(43) Pub. Date: Feb. 20, 2020

(54) Urine Deflector

(71) Applicants: Francis Baumann, Magnolia, TX (US); Joyce Baumann, Magnolia, TX (US)

(72) Inventors: Francis Baumann, Magnolia, TX (US); Joyce Baumann, Magnolia, TX (US)

(21) Appl. No.: 16/225,584

(22) Filed: Dec. 19, 2018

Related U.S. Application Data
(60) Provisional application No. 62/719,875, filed on Aug. 20, 2018.

(51) Int. Cl. A01K 23/00

(52) U.S. Cl. CPC A01K 23/00

(57) ABSTRACT

Provided herein is a urine deflector provided with a deflector shield attached to an adjustable strap for securing around the back and abdominal region of the pet's body. The deflector shield may be substantially L-shaped with a body portion and a flanged edge or flange portion substantially perpendicular to the body portion. The adjustable strap is fastened or otherwise secured to the flanged edge or flange portion.

### CROSS-REFERENCE TO RELATED APPLICATIONS

This non-provisional application claims benefit of priority under 35 U.S.C. § 119(e) of pending provisional application U.S. Ser. No. 62/719,875, filed Aug. 20, 2018, the entirety of which is hereby incorporated by reference.

### BACKGROUND OF THE INVENTION

### Field of the Invention

The present invention relates generally to the field of hygiene products for animals. More specifically, the present invention relates to a urine deflector for use on a canine.

### Description of the Related Art

Maintaining proper pet hygiene is a major concern for many pet owners. Pets are routinely exposed to poor hygienic conditions outdoors because their paws and body are unprotected. As a result, pets can experience various ailments including allergies, skin conditions and bacterial infections. Moreover, most pets, particularly canines, live indoors in close quarters with their owners and thus also expose humans including young children to pathogenic bacteria such as Salmonella, Campylobacter, Leptospira, Staphylococcus and Streptococcus. One of the common means of canines contracting skin conditions is during urination when urine splatters on their feet and chest, providing a fertile ground for fleas, ticks and bacteria. This self-inflicted condition can be avoided by use of suitable aids and devices that prevents splattering during urination. Such remedies are however unavailable to the pet owner currently.

There is therefore a recognized need in the art for pet hygiene products that prevent or reduce the incidence of splattering during urination. The prior art is deficient in this respect. The present invention fulfills this longstanding need and desire in the art.

### SUMMARY OF THE INVENTION

The present invention is directed to a urine deflector. The urine deflector comprises a deflector shield comprising a body portion with a flanged edge formed substantially perpendicular to the body portion and an adjustable strap affixed across the flanged edge of the deflector shield. The adjuster strap has a first end and a second end and comprises a slide adjuster and a means for fastening the first end to the second end.

The present invention also is directed to a urine deflector for improving animal hygiene. The deflector comprises a substantially L-shaped deflector shield comprising a body portion and a flanged portion formed substantially perpendicularly along an edge of the body portion, an adjustable strap and a means for fastening the deflector shield to the adjustable strap. The adjustable strap has a first end and a second end and comprises a slide adjuster and a means for buckling the first end of the strap to the second end of the strap.

The present invention is directed further to a related urine deflector for improving animal hygiene. The deflector comprises a substantially L-shaped deflector shield comprising a body portion and a flanged portion formed substantially perpendicularly along an edge of the body portion, an adjustable strap and a means for fastening the deflector shield to the adjustable strap. The adjustable strap has a first end and a second end and comprises a slide adjuster and a means for buckling the first end of the strap to the second end of the strap. At least two openings are provided through the flanged portion of the L-shaped deflector shield in alignment with at least two openings through the adjustable strap through which aligned openings the means for fastening are positioned.

### BRIEF DESCRIPTION OF THE DRAWINGS

These and other features, aspects, and advantages of the embodiments of the present disclosure will become better understood when the following detailed description is read with reference to the accompanying drawings in which like characters represent like parts throughout the drawing.

FIG. 1 is a top view of a urine deflector for use on a canine, where the attachments means is a channel disposed on the deflector for securing the deflector to a strap.

FIGS. 2A-2C show a urine deflector for use on a canine, where the deflector is attached by fasteners to the strap. FIG. 2A shows an exploded top view of the urine deflector. FIG. 2B shows an assembled top view of the urine deflector. FIG. 2C is a top view of the assembled urine deflector, showing the attachment point of the fasteners on the adjustable strap to secure the strap to the urine deflector.

FIG. 3 is an illustration of a stationary dog with the urine deflector strapped around the back and abdomen of a dog.

FIG. 4 is an illustration of a walking dog showing that the urine deflector stays in place when the dog is moving.

### DETAILED DESCRIPTION OF THE INVENTION

As used herein in the specification, “a” or “an” may mean one or more. As used herein in the claim(s), when used in conjunction with the word “comprising”, the words “a” or “an” may mean one or more than one.

As used herein “another” or “other” may mean at least a second or more of the same or different claim element or components thereof. Similarly, the word “or” is intended to include “and” unless the context clearly indicates otherwise. “Comprise” means “include.”

As used herein, the term “about” refers to a numeric value, including, for example, whole numbers, fractions, and percentages, whether or not explicitly indicated. The term “about” generally refers to a range of numerical values (e.g., +/−5-10% of the recited value) that one of ordinary skill in the art would consider equivalent to the recited value (e.g., having the same function or result). In some instances, the term “about” may include numerical values that are rounded to the nearest significant figure.

In one embodiment of the present invention, there is provided a urine deflector comprising a deflector shield comprising a body portion with a flanged edge formed substantially perpendicular to the body portion and an adjustable strap having a first end and a second end and comprising a slide adjuster disposed thereon and a means for fastening the first end to the second end where the strap is affixed across the flanged edge of the deflector shield.

In this embodiment, the deflector shield may comprise a liquid-proof material, a rain-proof material, a salt water-proof material, a sleet-proof material, or a snow-proof material independently made from polystyrene, polyvinyl chloride (PVC), nylon, poly(methyl methacrylate), High-Density Polyethylene (HDPE), Low-Density Polyethylene (LDPE), rubber, polyoxybenzylmethyleneglycolanhydride, polyvinylidene fluoride (PVDF), polychlorotrifluoroethylene (PCTFE), ethylene chlorotrifluoroethylene (ECTFE), chlorinated polyvinyl chloride (CPVC), or polytetrafluoroethylene (PTFE) or a combination of any of these materials. Particularly the liquid-proof material may be impervious to urine, rain, salt water, sleet or snow. In addition the deflector shield may have a length of about 5 inches to about 12 inches and a width of about 4 inches to about 12 inches.

Also in this embodiment the adjustable strap may comprise leather, nylon, polyester, hemp, metal, vinyl, or cotton, or a combination thereof. A representative adjustable strap may be adjustable to a length from about 12 inches to about 50 inches. In addition the adjustable strap may be affixed across the flanged edge of the deflector shield with a fastener, sewing, a radio frequency weld or a glue. Examples of the fastener are a hook-and-loop, or a grommet, or a button and buttonhole, or a poppas and eyelet, or a hook and eye, or a snap and press stud.

In addition in this embodiment the means for fastening the first end of the strap to the second end of the strap may be a quick-release buckle, or a hook-and-loop, or a grommet, or a button and buttonhole, or a poppas and eyelet, or a hook and eye, or a snap and press stud. Also the slide adjuster and means for fastening may be independently made from a polymer material, a metal, or a metal alloy or a combination thereof.

In another embodiment of the present invention, there is provided a urine deflector for improving animal hygiene comprising a substantially L-shaped deflector shield comprising a body portion and a flanged portion formed substantially perpendicularly along an edge of the body portion; an adjustable strap with a first end and a second end comprising a slide adjuster disposed thereon and means for buckling the first end of the strap to the second end of the strap; and means for fastening the deflector shield to the adjustable strap.

In this embodiment, the flanged portion of the L-shaped deflector shield may further comprise at least two openings therethrough and the adjustable strap may further comprise at least two openings through a middle portion thereof disposed in alignment with the openings through the flanged portion, said means for fastening positioned through said aligned openings. Also the adjustable strap may be fastened across the flanged portion of the deflector shield by sewing, radio frequency welding or gluing. Particularly, the adjustable strap may be fastened across the flanged portion of the deflector shield as described supra. In addition the means for buckling the first end of the strap to the second end of the strap may be a quick release buckle. Furthermore, the slide adjuster and the means for buckling independently are made from a polymer material, a metal, or a metal alloy or a combination thereof.

Also the deflector shield may comprise a urine-proof material, a rain-proof material, a salt water-proof material, a sleet-proof material, or a snow-proof material as described supra and the adjustable strap may comprise those materials as described supra. In addition the deflector shield may have the length and width as described supra and the adjustable strap may be adjustable to a length as described supra.

Provided herein is a urine deflector that improves pet hygiene during urination by deflecting urine to the ground instead of saturating the pet's body. Particularly, the pet may be a dog. Generally the urine deflector comprises a deflector shield and an adjustable strap affixed, attached or otherwise secured thereto, for example, removably secured to the deflector shield.

The deflector shield may be square, rectangular, or have any suitable shape or size that covers the animal's urine spray area such that urine is deflected to the ground. In a non-limiting example, the deflector shield may be substantially L-shaped comprising a body portion and a flanged end or flanged portion at a substantially right angle to or substantially perpendicular to the body portion. The deflector shield may be affixed, attached, secured, or fastened to the adjustable strap with a fastening means. Generally, any suitable commercially available fastening means including, but not limited to, radio frequency welding, sewing, gluing or fastening with fasteners may be used to affix the strap with the deflector shield. In one example, to accommodate some types of fasteners, the flanged end or flanged portion and a portion in the middle of the adjustable strap, excluding the ends or end portions may each comprise at least two or a plurality of holes therethrough in alignment such that the fastening means secures the adjustable strap to the deflector shield when fastened through the holes.

Shape and size are dependent on the type and the size of the animal. Correspondingly, the adjustable strap is adjustable to a suitable length depending on animal size. For example the adjustable strap may comprise a slide adjuster that allows adjustment of the length of the strap so that it fits comfortably around the back and abdominal region of the animal.

When positioned around the animal's abdomen, the ends of the adjustable strap may be fastened one to the other with a suitable fastening means, for example, but not limited to, a quick-release buckle, or a hook-and-loop, or a grommet, or a button and buttonhole, or a poppas and eyelet, or a hook and eye, or a snap and press stud. Particularly the fastening means may be a quick-release buckle comprising a set of complementarily engaging pieces, i.e., the latch body and the split bar. Each piece is attached to one of the strap ends whereupon engaging the pieces secures the strap around the animal and enables a quick release of the shield.

The deflector shield may be made of a urine-proof material, a rain-proof material, a salt water-proof material, a sleet-proof material, or a snow-proof material that an animal is likely to encounter outside. Such materials include, but are not limited to, polystyrene, polyvinyl chloride (PVC), nylon, poly(methyl methacrylate), High-Density Polyethylene (HDPE), Low-Density Polyethylene (LDPE), rubber, polyoxybenzylmethyleneglycolanhydride, polyvinylidene fluoride (PVDF), polychlorotrifluoroethylene (PCTFE), ethylene chlorotrifluoroethylene (ECTFE), chlorinated polyvinyl chloride (CPVC), or polytetrafluoroethylene (PTFE) or a combination of any of these materials. The adjustable strap may be made of any suitable material including, but not limited to leather, nylon, polyester, hemp, metal, vinyl, cotton or any combination of any of these materials. The slide adjuster and the quick release buckle may be made from any suitable material including, but not limited to, a polymer material, a metal, a metal alloy, a composite material or a combination of these materials.

As described below, the invention provides a number of advantages and uses, however such advantages and uses are not limited by such description. Embodiments of the present invention are better illustrated with reference to the Figure(s), however, such reference is not meant to limit the present invention in any fashion. The embodiments and variations described in detail herein are to be interpreted by the appended claims and equivalents thereof.

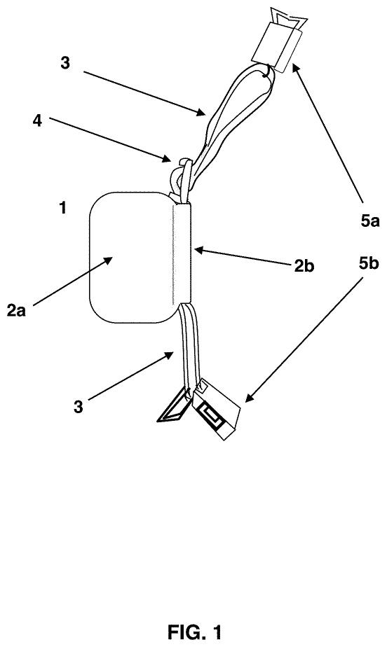

With reference to the attached drawings, FIG. 1 shows a urine deflector comprising a deflector shield 1 comprising a body portion 2a and a flanged edge 2b, an adjustable strap 3 affixed on the flanged edge of the deflector shield, and a slide adjuster 4. A quick-release buckle with a latch body 5a and a split-bar 5b configured to receive the latch in the latch body is attached at the ends of the adjustable strap.

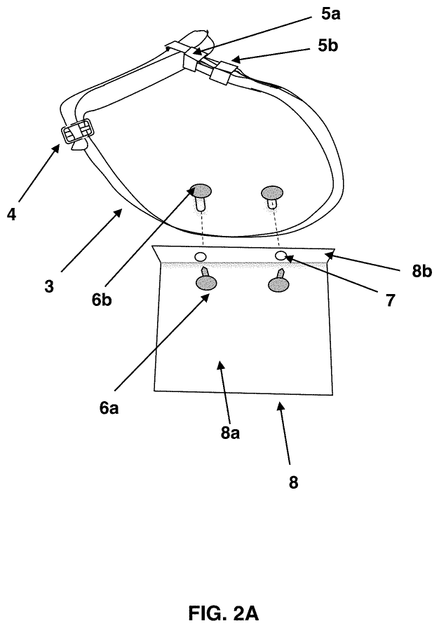

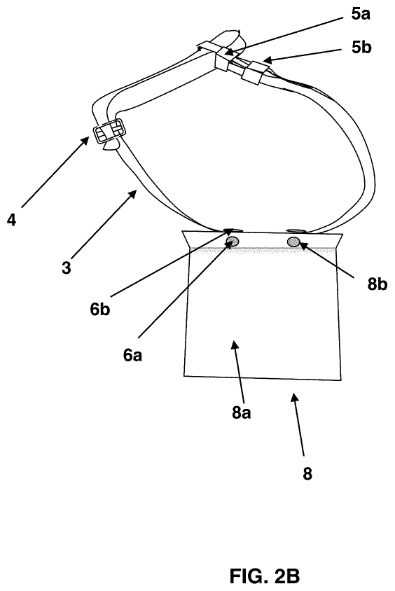

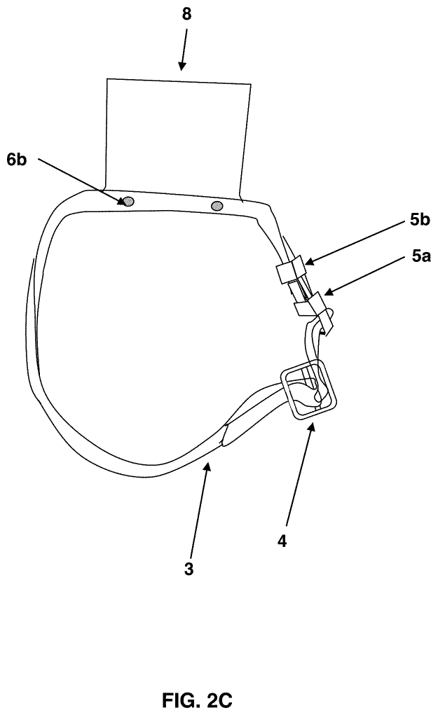

FIG. 2A illustrates an exploded view of a urine deflector comprising a L-shaped deflector shield 8, comprising a body portion 8a and a flanged portion 8b, an adjustable strap 3 affixed by complementary fastener pieces 6a and 6b, that pass-through openings 7 on the flanged portion 8b of the deflector shield, and a slide adjuster 4. A first quick-release buckle with a latch body 5a and a split-bar 5b configured to receive the latch in the latch body is attached at the ends of the adjustable strap.

With continuous reference to FIG. 2A, FIG. 2B illustrates an assembled urine deflector comprising the deflector shield attached on a flanged portion to an adjustable strap by means of the fastener pieces, a slide adjuster and a quick-release buckle with a latch body and a split-bar attached at the ends of the adjustable strap.

With continuous reference to FIGS. 2A and 2B, FIG. 2C illustrates a bottom view of the assembled urine deflector showing the fastener piece 6b on the strap side securing the strap to the deflector shield by engaging fastener piece 6a (not shown), on the deflector shield side.

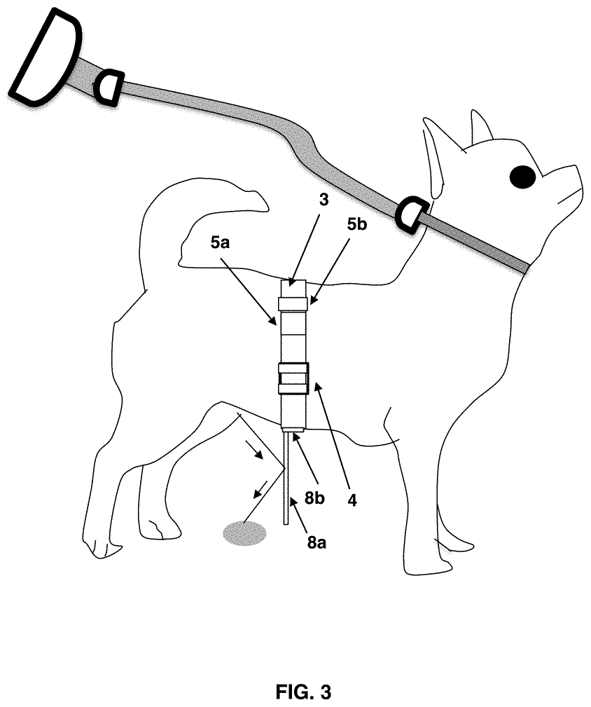

With continuous reference to FIGS. 2A to 2C, FIG. 3 shows a drawing of the urine deflector strapped in front of the loin region, around the back and abdomen of a stationary dog, where the flanged portion 8b of the deflector shield is at right angles to the body portion 8a so that the body portion is positioned below the mid-section of the animal's abdomen so the urine can be deflected to the ground and away from the animals body as shown (arrow).

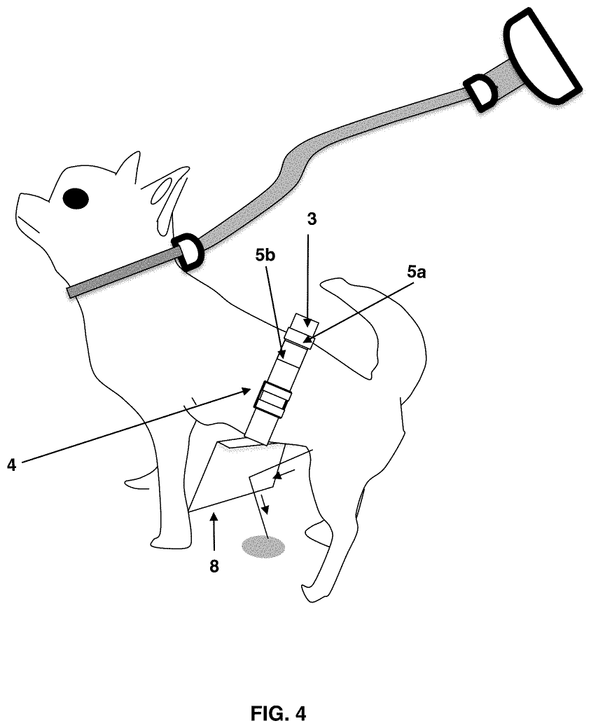

With continuous reference to FIGS. 2A to 2C and FIG. 3, FIG. 4 shows a single screen capture view of a walking dog showing that the urine deflector 8 stays in place when the dog is moving.

What is claimed is:

1. A urine deflector comprising:
a deflector shield comprising a body portion with a flanged edge formed substantially perpendicular to the body portion; and
an adjustable strap having a first end and a second end and comprising a slide adjuster disposed thereon and means for fastening the first end to the second end, said strap affixed across the flanged edge of the deflector shield.

2. The urine deflector of claim 1, wherein the deflector shield comprises a liquid-proof material, a rain-proof material, a salt water-proof material, a sleet-proof material, or a snow-proof material independently made from polystyrene, polyvinyl chloride, nylon, poly(methyl methacrylate), High-Density Polyethylene (HDPE), Low-Density Polyethylene (LDPE), rubber, polyoxybenzylmethyleneglycolanhydride, polyvinylidene fluoride, polychlorotrifluoroethylene, ethylene chlorotrifluoroethylene, chlorinated polyvinyl chloride, or polytetrafluoroethylene or a combination thereof.

3. The urine deflector of claim 2, wherein the liquid-proof material is impervious to urine, rain, salt water, sleet, or snow.

4. The urine deflector of claim 1, wherein the deflector shield has a length of about 5 inches to about 12 inches and a width of about 4 inches to about 12 inches.

5. The urine deflector of claim 1, wherein the adjustable strap comprises leather, nylon, polyester, hemp, metal, vinyl, or cotton, or a combination thereof.

6. The urine deflector of claim 1, wherein the adjustable strap is adjustable to a length from about 12 inches to about 50 inches.

7. The urine deflector of claim 1, wherein the means for fastening the first end of the strap to the second end of the strap is a quick-release buckle, or a hook-and-loop, or a grommet, or a button and buttonhole, or a poppas and eyelet, or a hook and eye, or a snap and press stud.

8. The urine deflector of claim 1, wherein the slide adjuster and means for fastening are independently made from a polymer material, a metal, or a metal alloy or a combination thereof.

9. The urine deflector of claim 1, wherein the adjustable strap is affixed across the flanged edge of the deflector shield with a fastener, sewing, a radio frequency weld or a glue.

10. The urine deflector of claim 9, wherein the fastener is a hook-and-loop, or a grommet, or a button and buttonhole, or a poppas and eyelet, or a hook and eye, or a snap and press stud.

11. A urine deflector for improving animal hygiene comprising:
a substantially L-shaped deflector shield comprising a body portion and a flanged portion formed substantially perpendicularly along an edge of the body portion;
an adjustable strap with a first end and a second end comprising:
a slide adjuster disposed thereon;
means for buckling the first end of the strap to the second end of the strap; and
means for fastening the deflector shield to the adjustable strap.

12. The urine deflector of claim 11, wherein the flanged portion of the L-shaped deflector shield further comprises at least two openings therethrough and the adjustable strap further comprises at least two openings through a middle portion thereof disposed in alignment with the openings through the flanged portion, said means for fastening positioned through said aligned openings.

13. The urine deflector of claim 11, wherein the means for buckling the first end of the strap to the second end of the strap is a quick release buckle.

14. The urine deflector of claim 11, wherein the deflector shield comprises a urine-proof material, a rain-proof material, a salt water-proof material, a sleet-proof material, or a snow-proof material independently made from polystyrene, polyvinyl chloride, nylon, poly(methyl methacrylate), High-Density Polyethylene (HDPE), Low-Density Polyethylene (LDPE), rubber, polyoxybenzylmethyleneglycolanhydride, polyvinylidene fluoride, polychlorotrifluoroethylene, ethylene chlorotrifluoroethylene, chlorinated polyvinyl chloride, or polytetrafluoroethylene or a combination thereof.

15. The urine deflector of claim 11, wherein the deflector shield has a length from about 5 inches to about 12 inches and a width from about 4 inches to about 12 inches.

16. The urine deflector of claim 11, wherein the adjustable strap is fastened across the flanged portion of the deflector shield by sewing, radio frequency welding or gluing.

17. The urine deflector of claim 11, wherein the means for fastening the deflector shield to the adjustable strap is a hook-and-loop, a grommet, a button and buttonhole, a poppas and eyelet, a hook and eye and a snap, or a press stud.

18. The urine deflector of claim 11, wherein the adjustable strap comprises leather, nylon, polyester, hemp, metal, vinyl, or cotton, or a combination thereof.

19. The urine deflector of claim 11, wherein the adjustable strap is adjustable to a length from about 12 inches to about 50 inches.

20. The urine deflector of claim 11, wherein the slide adjuster and the means for buckling are independently made from a polymer material, a metal, or a metal alloy or a combination thereof.
